(19) United States
(12) Patent Application Publication
(10) Pub. No.: US 2008/0050625 A1
(43) Pub. Date: Feb. 28, 2008

(54) Fuel Cell Valve With Hydrophobically Enhanced Surface

(75) Inventors: Dieter Kaimann, Mainz (DE); Dirk Wexel, Mainz (DE)

Correspondence Address: GENERAL MOTORS CORPORATION;LEGAL STAFF, MAIL CODE 482-C23-B21, P O BOX 300, DETROIT, MI, 48265-3000, US

(73) Assignee: GM GLOBAL TECHNOLOGY OPERATIONS, INC., Detroit, MI (US)

(21) Appl. No.: 11/466,807

(22) Filed: Aug. 24, 2006

(51) Int. Cl. H01M 8/04; F16K 25/00

(52) U.S. Cl. 429/22; 429/34; 251/368

(57) ABSTRACT

A product including a control valve. The control valve includes a body having a passage therethrough defined by an inner surface. A movable part is provided for closing the passage. At least one of the inner surface or the movable part includes a hydrophobically enhanced surface.

### TECHNICAL FIELD

The field to which the disclosure generally relates includes fuel cell systems including valves.

### BACKGROUND

Fuel cell systems are known to include reacting gas conduits. The flow of a reacting gas into a fuel cell stack may be controlled by a valve. It has also been known to humidify the cathode reaction gas and/or the anode reaction gas. Under certain operating conditions, water may condense in the reacting gas flow control valves. This water may freeze, causing the valve to be stuck in an open or closed position or to operate improperly.

### SUMMARY OF EXEMPLARY EMBODIMENTS OF THE INVENTION

One embodiment of the invention includes a product having a fuel cell reaction gas control valve, the control valve including a body having a passage therethrough defined by an inner surface. A movable part for closing the passage is provided. At least one of the inner surface and the movable part having a hydrophobically enhanced surface.

Other exemplary embodiments of the present invention will become apparent from the detailed description provided hereinafter. It should be understood that the detailed description and specific examples, while indicating the exemplary embodiment of the invention, are intended for purposes of illustration only and are not intended to limit the scope of the invention.

### BRIEF DESCRIPTION OF THE DRAWINGS

Exemplary embodiments of the present invention will become more fully understood from the detailed description and the accompanying drawings, wherein:

FIG. 1 is a schematic illustration of a fuel cell system according to one embodiment of the invention.

FIG. 2 is a prospective view of selective components of a fuel cell system according to one embodiment of the invention.

FIG. 3 illustrates a reacting gas control valve according to one embodiment of the invention.

FIG. 4 illustrates a flap for a reacting gas control valve according to one embodiment of the invention.

### DETAILED DESCRIPTION OF EXEMPLARY EMBODIMENTS

The following description of the embodiment(s) is merely exemplary in nature and is in no way intended to limit the invention, its application, or uses.

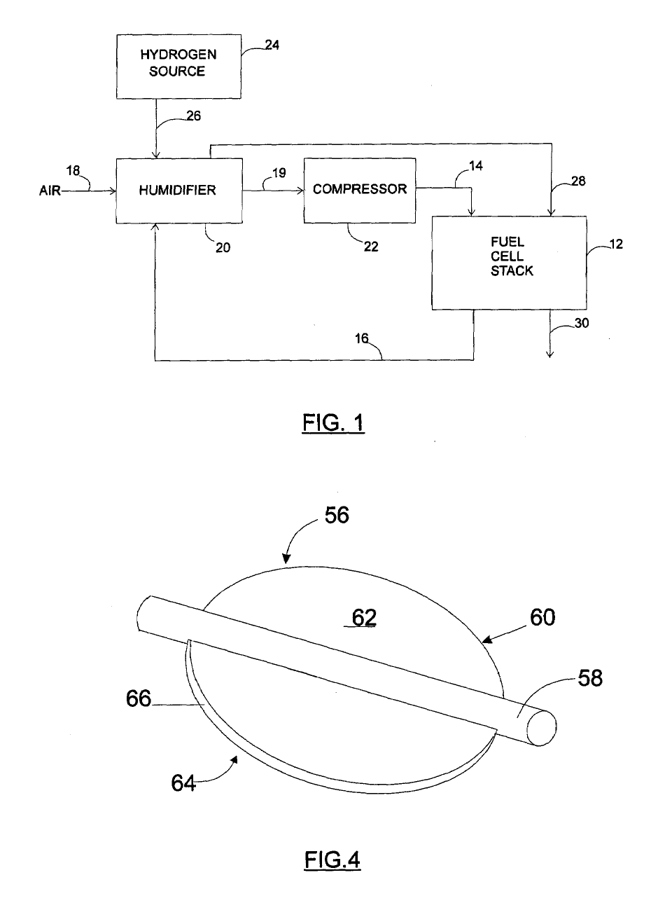

Referring now to FIG. 1, one embodiment of the invention includes a fuel cell system 10 including a fuel cell stack 12. The fuel cell stack 12 includes a plurality of membrane electrode assemblies, each including an ionically conductive membrane having an anode face and a cathode face. A cathode electrode overlies the cathode face and a cathode gas diffusion media overlies the cathode electrode. An anode electrode overlies the anode face and an anode gas diffusion media material overlies the anode electrode. Each membrane electrode assembly is sandwiched between a pair of bipolar plates. The bipolar plates include reacting gas flow fields formed in opposite faces thereof. The bipolar plates may further include coolant passages therethrough. A cathode inlet line 14 delivers cathode reactant gas, such as oxygen, to the fuel cell stack 12. The cathode reactant gas may be provided by air entering through conduit 18 into a humidifier 20 and thereafter pressurized by a compressor 22 before entering the fuel cell stack 12. Excess cathode reactant gas exits the fuel cell stack 12 through conduit 16. A hydrogen source 24 is provided which may be compressed hydrogen gas, liquid hydrogen, or hydrogen from fuel reformation. Optionally, the hydrogen may be provided through conduit 26 into a humidifier which humidifies the hydrogen gas prior to entering the fuel cell stack 12 through anode inlet 28. Excess hydrogen exits the fuel cell stack 12 through anode outlet 30.

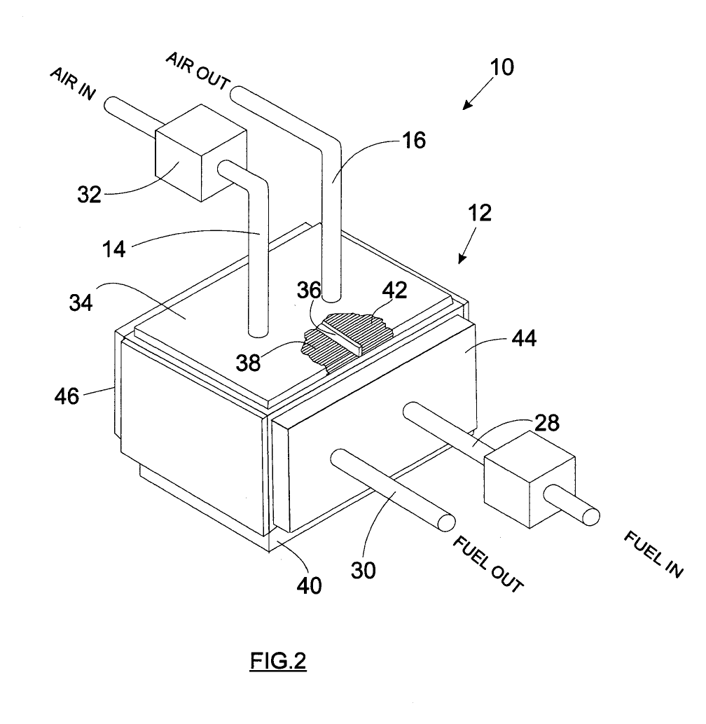

Referring now to FIG. 2, one embodiment of the invention includes a fuel cell reactant gas control valve 32. The control valve 32 may be positioned in the cathode inlet line 14 or the anode inlet line 28. The arrangement of the inlet and outlet lines and the fuel cell stack are not particularly important to the present invention. In one embodiment of the invention, the cathode inlet line 14 and outlet line 16 are connected to a cathode manifold 34 which may include a divider plate 36. Air flows into the manifold 34 on one side of the divider plate 36 and through a first set of bipolar plates 38 into a turn-around manifold 40 and back through a second set of bipolar plates 42. Hydrogen gas enters an anode manifold 44 similarly constructed to the cathode manifold 34. The hydrogen flows through the second set of bipolar plates 42 and into an anode turn-around manifold 46 and back through the first set of bipolar plates 38 exiting the anode outlet conduit 30.

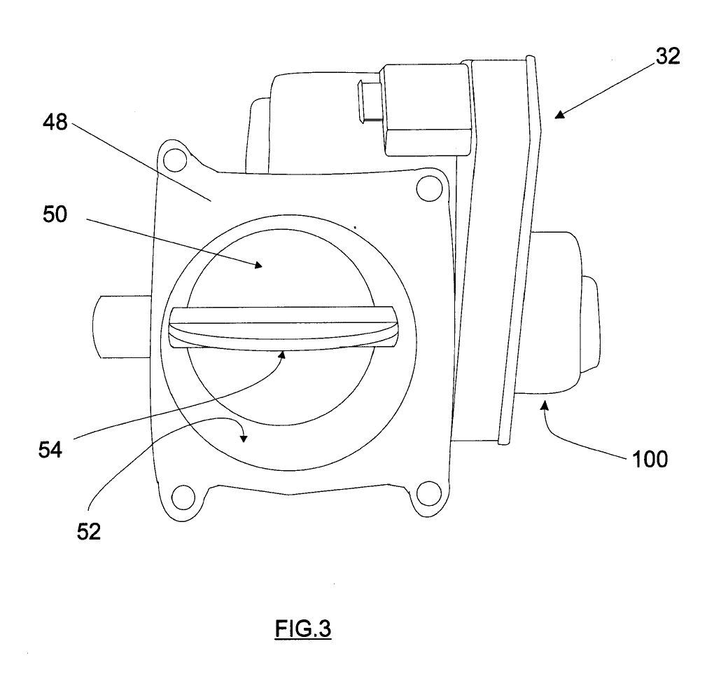

Referring now to FIGS. 3 and 4, one embodiment of the invention includes a fuel cell reactant gas control valve 32 including a body portion 48 having a passage 50 therethrough defined by an inner surface 52. The inner surface 52 may be formed by the body 48 or may be provided by a sleeve (not shown) received in a bore formed through the body 48. The valve 32 includes a movable part 54 having a portion constructed and arranged to block the passage 50 through the body 48. The valve 32 may be of any type known to those skilled in the art including, but not limited to, a ball valve, globe valve, gate valve, flap valve, piston valve, diaphragm valve or the like. In one embodiment of the invention, the movable part 54 includes a flapper including a stem 58 pivotally mounted to the body 48 and a flap 60 extending outwardly from the stem 58. An electric motor 100 may be attached to the stem 58 of the flapper 56 to rotate the flapper 56 from an open position allowing reacting gases to pass through the valve to a closed position wherein the passage is blocked, thereby preventing reacting gases from passing through the valve. The flap 60 includes a first face 62 and an opposite second face 64 and a side edge 66 extending therebetween. In one embodiment of the invention, the inner surface 52, first face 62, second face 64 or side edge 66 of the flapper 56 includes a hydrophobically enhanced surface. The hydrophobically enhanced surface may be provided by any of a variety of means, including mechanically roughening one of the surfaces 52, 62, 64, 66 to enhance the hydrophobic character of the surface. In another embodiment, a hydrophobic coating is deposited on at least one of the surfaces 52, 62, 64, 66. Any hydrophobic coating sufficient to increase the contact angle of the surfaces to greater than 90°, greater than 100° or greater than 150° is within the scope of the invention. In one embodiment of the invention, the hydrophobic coating includes a hard wax having a melting point greater than 100° C., or a melting point ranging from 100° C.-600° C. In various embodiments of the invention, the coating may include a polyethylene, silicone, polypropylene, polytetrafluoroethylene or nano particles. In another embodiment of the invention, the surfaces 52, 62, 64, 66 may be hydrophobically enhanced by mechanically roughening the surfaces including, for example, sandblasting, shot peening, milling, or grinding. In one embodiment of the invention, surfaces of the valve body inner surface 52 and moveable part 54 may be chemically roughened, for example, by at least one of anodic oxidation or caustic/acid treatment. In one embodiment of the invention, the hydrophobic coating is a coating including nanoparticles available from BASF Corporation under the trademark LOTUS EFFECT. In another embodiment of the invention, the hydrophobic coating is a hard wax available from Tromm GmbH under the trade names Tece-Wachs N322 FL, Polycerit PT90, and Polarwachs PT30.

In one embodiment of the invention, the body of the control valve is prewarmed, and thereafter a hot wax is applied to the inner surface 52 and the surfaces 62, 64 and 66 of the flapper. Excess wax is removed by warming the body moderately and thereafter cooling the valve. The hydrophobically enhanced surface causes water that condenses in the valve to be maintained in droplet form and thus requiring less force to float the droplets out of the valve than the force that would be required to remove water from the valve if the valve included hydrophilic surfaces.

In other embodiments of the invention, fuel cell valves having a hydrophobically enhanced surface may be employed in downstream lines (conduits), for example, in recirculation gas stream lines (conduits) or in outlet lines (conduits) to control outlet pressure or to prevent air intrusion. Further, the use of a control valve with a hydrophobically enhanced surface is not limited to fuel cell application. In other embodiments of the invention, a control valve with a hydrophobically enhanced surface may be used in any application involving wet gas streams.

The above description of embodiments of the invention is merely exemplary in nature and, thus, variations thereof are not to be regarded as a departure from the spirit and scope of the invention.

What is claimed is:

1. A product comprising:
a fuel cell control valve comprising a body having a passage therethrough defined by an inner surface,
a movable part for closing the passage,
and wherein at least one of the inner surface or movable part includes a hydrophobically enhanced surface.

2. A product as set forth in claim 1 wherein the hydrophobically enhanced surface has a contact angle greater than 90°.

3. A product as set forth in claim 1 wherein the hydrophobically enhanced surface has a contact angle greater than 100°.

4. A product as set forth in claim 1 wherein the hydrophobically enhanced surface has a contact angle greater than 150°.

5. A product as set forth in claim 1 wherein the hydrophobically enhanced surface comprises a coating comprising a wax.

6. A product as set forth in claim 5 wherein the wax has a melting temperature greater than 100° C.

7. A product as set forth in claim 5 wherein the wax has a melting point between 100° C.-160° C.

8. A product as set forth in claim 1 wherein the hydrophobically enhanced surface comprises a coating comprising a polyethylene.

9. A product as set forth in claim 1 wherein the hydrophobically enhanced surface comprises a coating comprising a silicone.

10. A product as set forth in claim 1 wherein the hydrophobically enhanced surface comprises a coating comprising nanoparticles.

11. A product as set forth in claim 1 wherein the hydrophobically enhanced surface comprises a coating comprising polypropylene.

12. A product as set forth in claim 1 wherein the hydrophobically enhanced surface comprises a coating comprising polytetrafluoroethylene.

13. A product as set forth in claim 1 wherein the hydrophobically enhanced surface comprises a surface that has been mechanically roughened.

14. A product as set forth in claim 1 wherein the movable part comprises a ball.

15. A product as set forth in claim 1 wherein the movable part comprises a flapper.

16. A product as set forth in claim 1 wherein the movable part comprises a gate.

17. A product as set forth in claim 1 wherein the movable part comprises a piston.

18. A product as set forth in claim 1 wherein the movable part comprises a diaphragm.

19. A product as set forth in claim 1 wherein the hydrophobically enhanced surface comprises a surface that has been mechanically roughened by at least one of sandblasting, shot peening, milling or grinding.

20. A product as set forth in claim 1 wherein the hydrophobically enhanced surface comprises a surface that has been chemically roughened.

21. A product as set forth in claim 1 wherein the hydrophobically enhanced surface comprises a surface that has been chemically roughened using at least one of anodic oxidation or caustic/acid treatment.

22. A product as set forth in claim 1 further comprising a fuel cell stack and an anode inlet conduit, anode outlet conduit, cathode inlet conduit and cathode outlet conduit each connected to the fuel cell stack, and wherein the fuel cell control valve is connected to at least one of the anode inlet conduit, the anode outlet conduit, the cathode inlet conduit or cathode outlet conduit.

23. A product as set forth in claim 22 further comprising a humidifier connected to at least one of the anode inlet conduit or cathode inlet conduit to humidify a reactant gas flowing into the stack.

24. A product as set forth in claim 1 further comprising a fuel cell stack and a cathode inlet conduit or cathode outlet conduit connected to the fuel cell stack, and a humidifier connected to at least one of the cathode inlet or cathode outlet conduit to humidify a cathode reactant gas flowing into the stack and wherein the fuel cell reactant gas control valve is connected to one of the cathode inlet conduit or cathode outlet conduit.

25. A product comprising:
a control valve comprising a body having a passage therethrough defined by an inner surface,
a movable part for closing the passage,
and wherein the control valve is moveable from a closed position to an open position, and moveable to partially open positions therebetween, and further comprising a conduit connected to the control valve and constructed and arranged to flow a wet gas stream through the conduit and the control valve when the control valve is an open or partial open position, and the hydrophobically enhanced surface being sufficient to prevent the value from being frozen in a position due to solidification of moisture from a wet gas stream flowing through the control valve,
and wherein at least one of the inner surface or movable part includes a hydrophobically enhanced surface.

26. A product as set forth in claim 25 wherein the hydrophobically enhanced surface comprises a coating comprising a wax.

27. A product as set forth in claim 26 wherein the wax has a melting temperature greater than 100° C.

28. A product as set forth in claim 26 wherein the wax has a melting point between 100° C.-160° C.

29. A product as set forth in claim 25 wherein the hydrophobically enhanced surface comprises a coating comprising a polyethylene.

30. A product as set forth in claim 25 wherein the hydrophobically enhanced surface comprises a coating comprising a silicone.

31. A product as set forth in claim 25 wherein the hydrophobically enhanced surface comprises a coating comprising nanoparticles.

32. A product as set forth in claim 25 wherein the hydrophobically enhanced surface comprises a coating comprising polypropylene.

33. A product as set forth in claim 25 wherein the hydrophobically enhanced surface comprises a coating comprising polytetrafluoroethylene.

34. A product as set forth in claim 25 wherein the hydrophobically enhanced surface comprises a surface that has been mechanically roughened.

35. A product as set forth in claim 25 wherein the movable part comprises at least one of a globe, ball, flapper, gate, piston or diaphragm.

36. A product as set forth in claim 25 wherein the hydrophobically enhanced surface comprises a surface that has been mechanically roughened by at least one of sandblasting, shot peening, milling or grinding.

37. A product as set forth in claim 25 wherein the hydrophobically enhanced surface comprises a surface that has been chemically roughened.

38. A product as set forth in claim 25 wherein the hydrophobically enhanced surface comprises a surface that has been chemically roughened using at least one of anodic oxidation or caustic/acid treatment.
